(19) United States
(12) Patent Application Publication
(10) Pub. No.: US 2007/0222166 A1
(43) Pub. Date: Sep. 27, 2007

(54) Lockout tool box

(76) Inventor: Rodolfo Ruiz, El Paso, TX (US)

Correspondence Address: Rodolfo Ruiz, 7322 Mojave, El Paso, TX, 79915, US

(21) Appl. No.: 11/389,582

(22) Filed: Mar. 27, 2006

(51) Int. Cl. B62B 3/00

(52) U.S. Cl. 280/47.35; 280/47.34

(57) ABSTRACT

A toolbox that is both functional and provides a lockout system for added security. The toolbox has a scissor-spring mechanism which aids in uncovering bottom portion of toolbox. A rectangular shaped body which holds one box over another to provide the bottom portion a secure area with the most protection. The lower portion provides oversized space for storage of tools and helps secure tools. A security lock is located on the upper side of the tool box which secures the entire box. The toolbox is equipped with moving tires which can be locked. Handles are provided for the purpose of aid in lifting and hauling the toolbox.

### FIELD OF THE INVENTION

The present invention relates to . . . and, more particularly, to . . . protection of tools in a manner more secure with proper lockout device.”

### BACKGROUND OF THE INVENTION

Ever since tool boxes were invented, there has been a need to store the tools safely in order to prevent theft and locate them when needed. A central, stable location for storing and safeguarding one or more tools is desired by all industrial and commercial trades.

Prior toolboxes have only a key lock mechanism or slot for key lock or combination lock.

Prior toolboxes are inherently insecure, as more expensive tools are placed in toolbox. There is a tendency to walk away with the possibility of the tools being exposed without proper security.

It is therefore an object of the invention to provide a lockout toolbox for tools.

It is another object of the invention to provide a lifting mechanism to bottom portion of toolbox.

It is a further object of the invention to provide a toolbox that provides a spacious compartment to hold all tools.

It is another object of the invention to provide a toolbox having a power surge protector in order to have easier access to plug tools into the toolbox instead of a wall outlet.

### SUMMARY OF THE INVENTION

In accordance with the present invention, there is provided a toolbox that is both functional and provides a lockout system for added security. The toolbox has a scissor-spring mechanism which aids in uncovering bottom portion of toolbox. A rectangular shaped body which holds one box over another to provide the bottom portion a secure area with the most protection. The top part of toolbox provides space for layout of tools and also has a security device implemented to lock tools when not in use. The middle section provides a tray for necessary items and is protected by top portion of toolbox. The lower portion provides oversized space for storage of tools and helps secure tools. A security lock is located on the upper side of the tool box which secures the entire box. The toolbox also provides a receptacle power surge protector with cord. The toolbox is equipped with moving tires which can lock with brakes provided. Handles are provided for the purpose of aid in lifting and hauling the toolbox.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top view of a lockout toolbox with front handle;

FIG. 2 is a top detail view of a top portion of lockout toolbox with front handle and hinges for lid of toolbox;

FIG. 3 is a right detail view of a toolbox including key lock mechanism, extended handle to haul toolbox, release to raise toolbox to open position and brake for each swivel wheel;

FIG. 4 is a left detail view of a toolbox including extended handle to haul toolbox, release to raise toolbox to open position, and electrical power surge protector;

FIG. 5 is a front detail view of a toolbox including second locking mechanism, side view of extended handle, side view of handle bar, swivel tire, brake and regular tire;

FIG. 6 is a rear detail view of a toolbox including side view of extended handle, side view of handle bar, rear view of lid, swivel tire, brake and regular tire;

FIG. 7 is a front detail view of a toolbox with view of hidden storage compartment and partial view of the scissor-spring mechanism to keep toolbox open;

FIG. 8 is a rear detail view of a toolbox with second door to hidden storage compartment and partial view of scissor-spring mechanism to keep toolbox open;

FIG. 9 is a left detail view of an open toolbox including electrical power surge protector and hidden drawer above hidden storage compartment;

FIG. 10 is a right detail view of an open toolbox including view of hidden drawer above hidden storage compartment, extended handle to pull toolbox, key lock mechanism and release;

FIG. 11 is a detail view of a springlock for outer casing;

FIG. 12 is a detail view of an inner compartments of hidden drawer located above hidden storage compartment;

FIG. 13 is a bottom detail view of a toolbox showing the swivel tires, regular tires and frame; and

FIG. 14 is a detail view of an inside of scissor-spring mechanism.

For purposes of clarity and brevity, like elements and components will bear the same designations and numbering throughout the Figures.

### DESCRIPTION OF THE PREFERRED EMBODIMENT

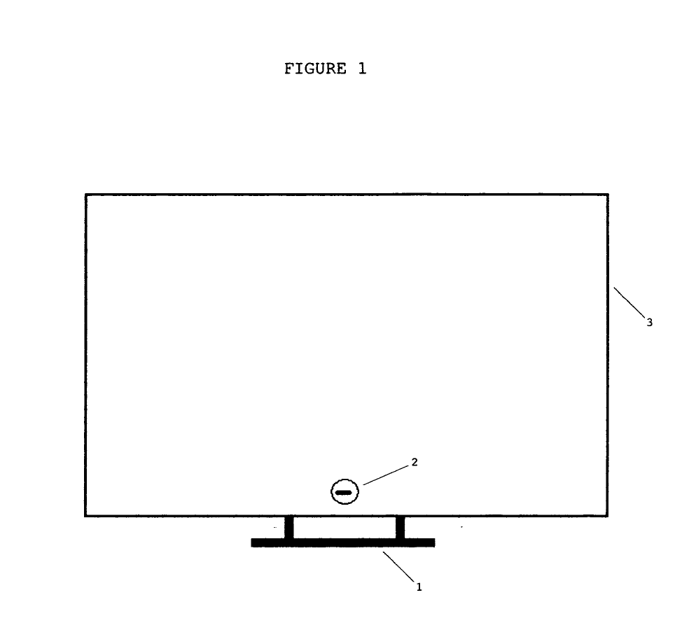

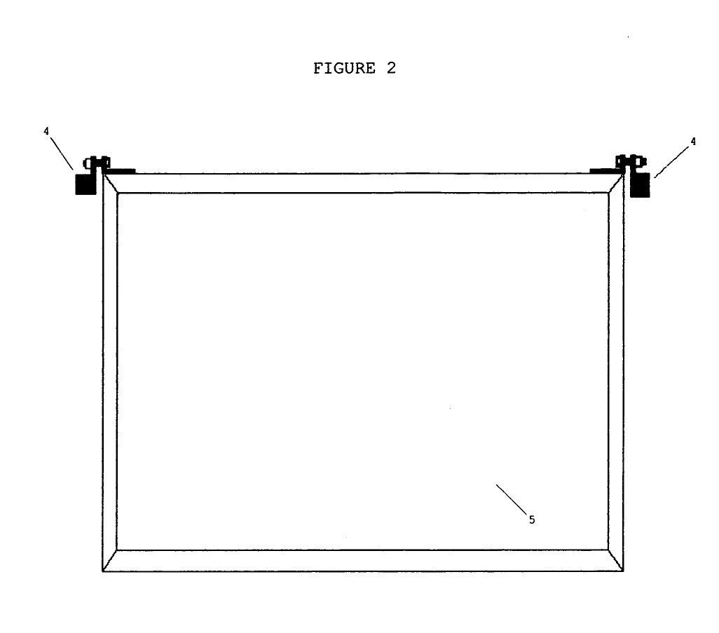

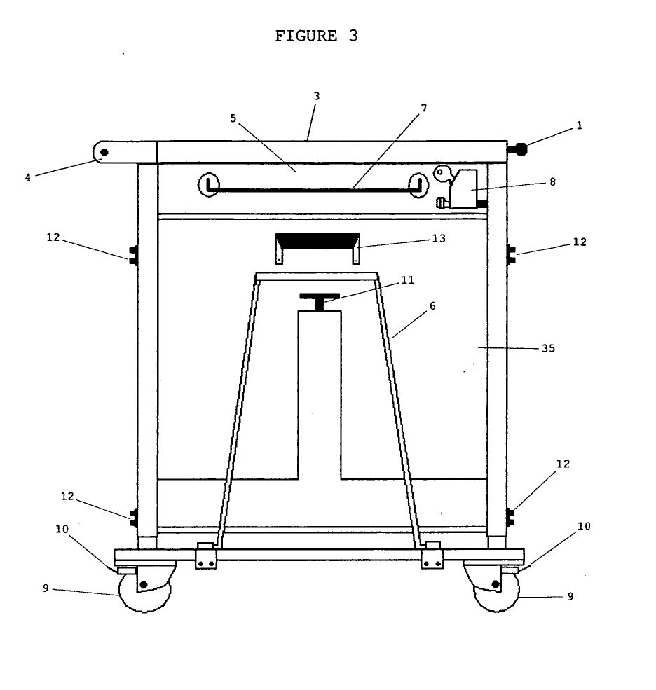

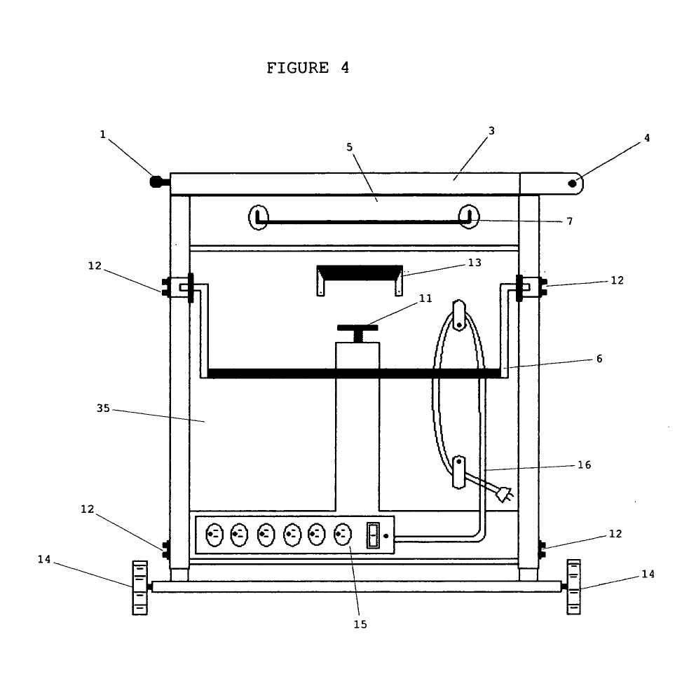

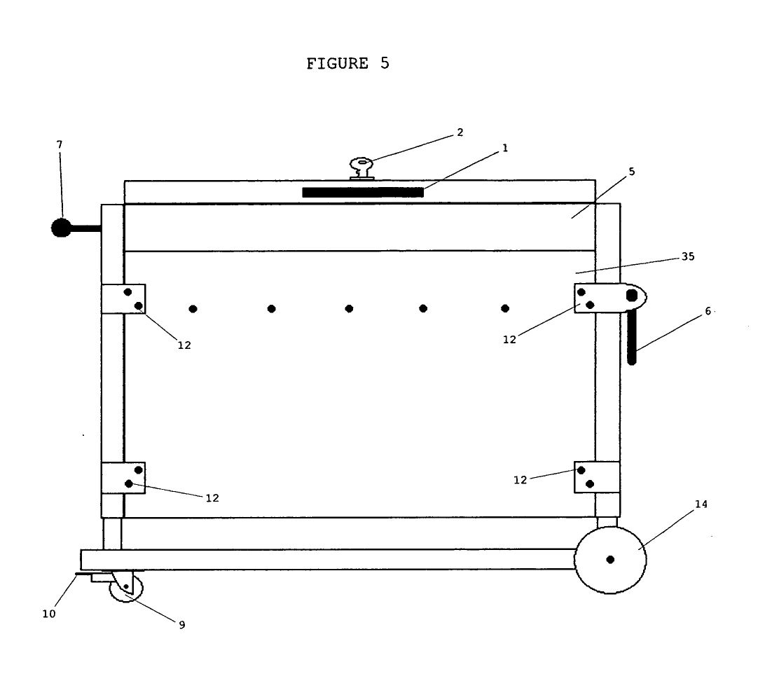

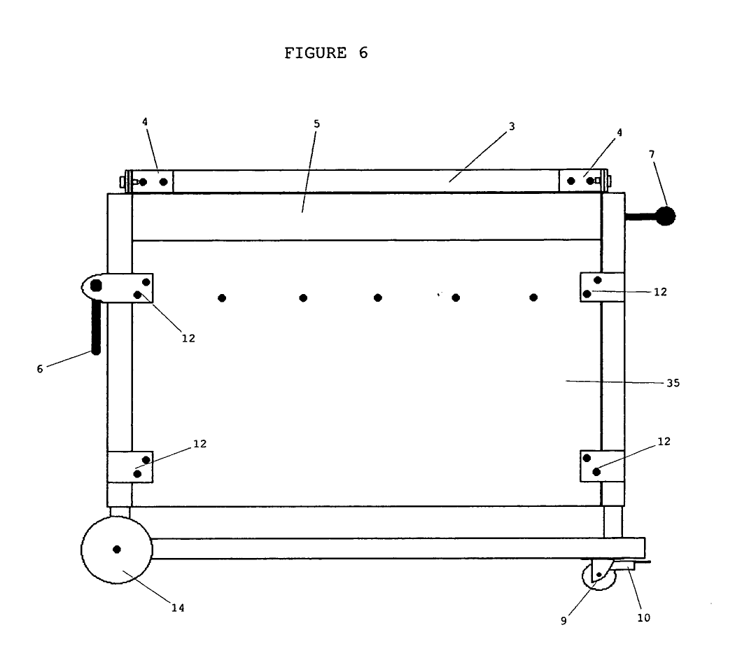

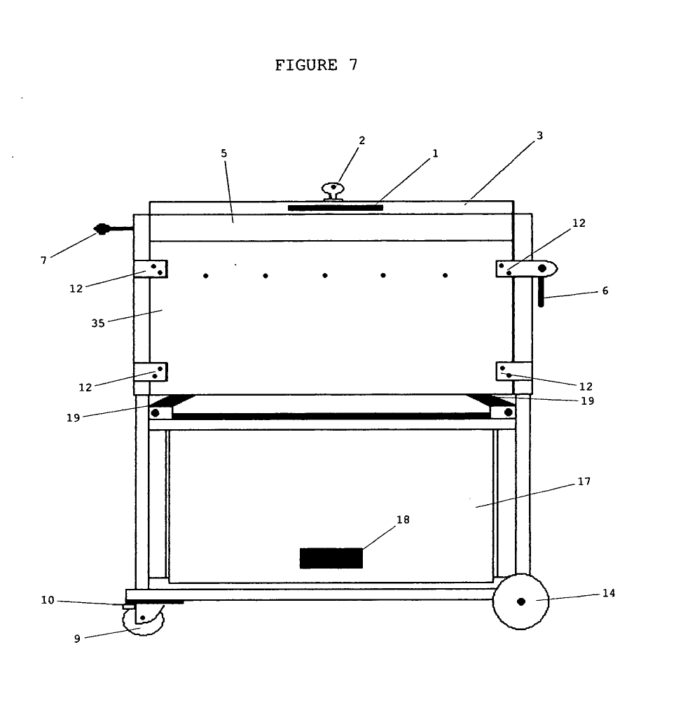

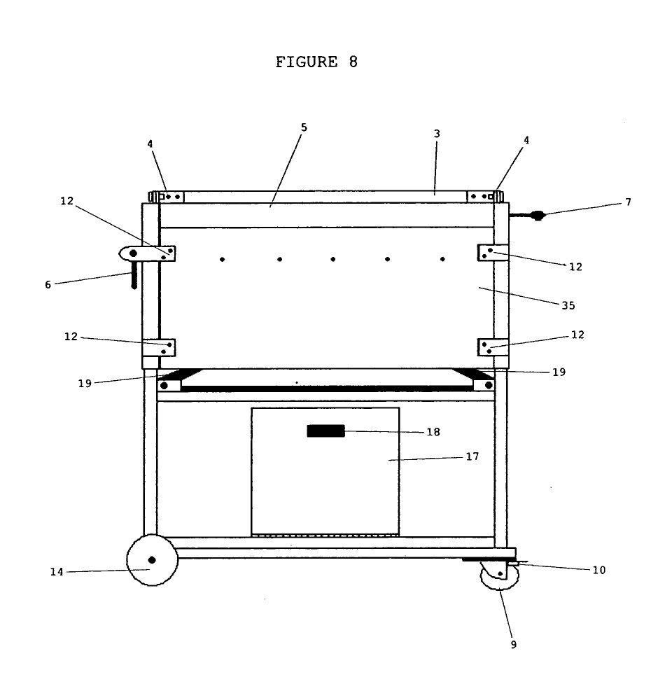

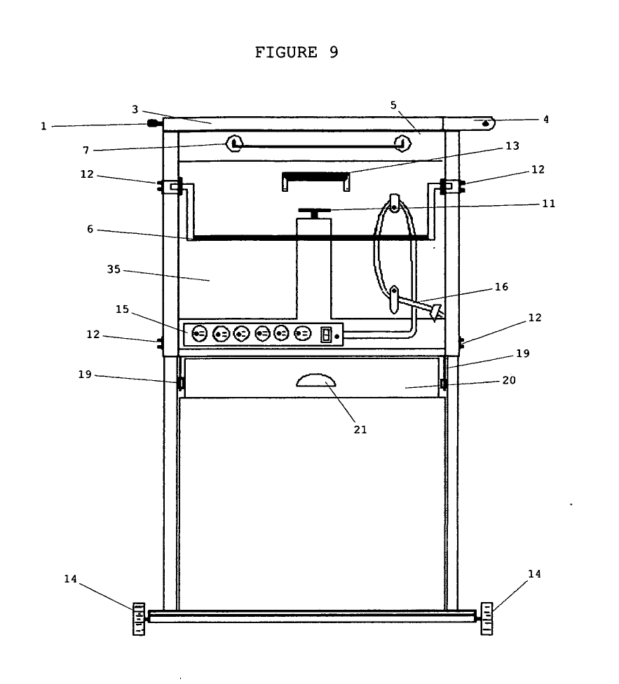

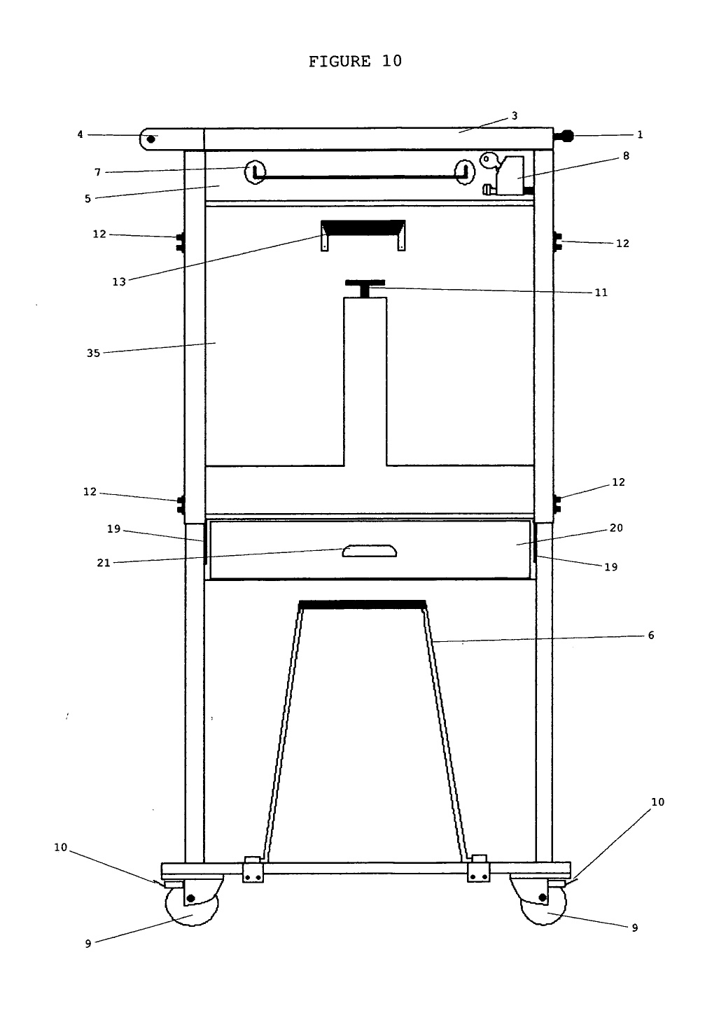

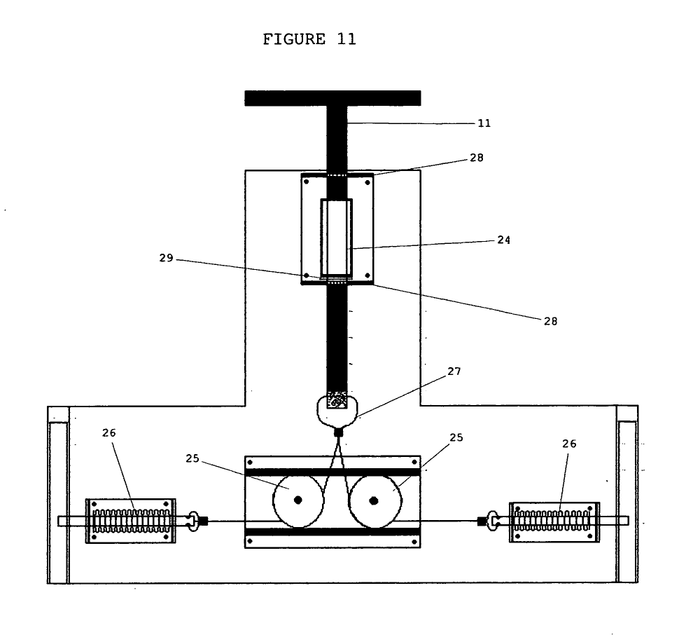

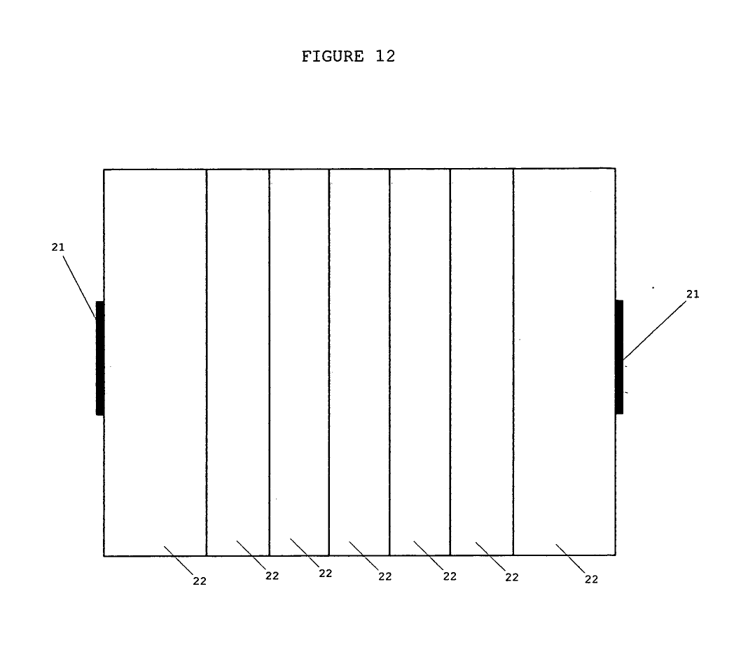

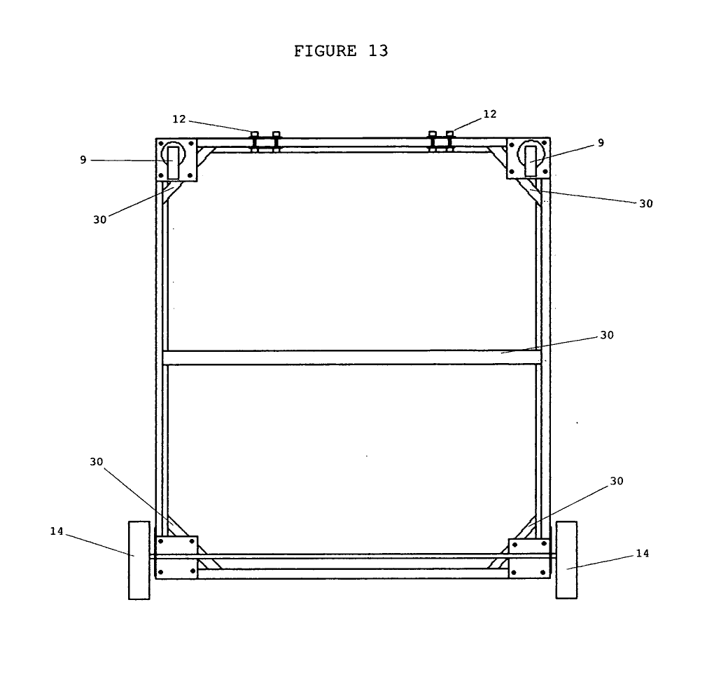

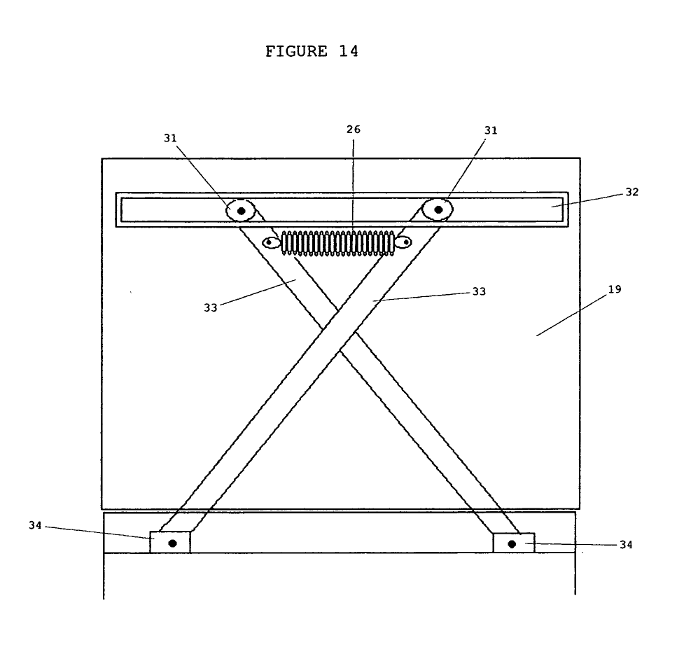

FIG. 1 is a top view of lockout toolbox with front handle 1. The front handle 1 is used for the purpose of opening the top lid 3 of the toolbox. The top lid 3 is connected to the toolbox by hinges 4. The top lid 3 covers the top compartment 5 and is secured with a key lock 2. The top compartment 5 is used for multiple purposes, such as holding implements and accessories. FIG. 2 is a top detail view of the top compartment 5 of lockout toolbox with front handle 1 and hinges 4 for top lid 3 of toolbox. FIG. 3 is a right detail view of toolbox including key lock mechanism 8, extended handle 6 to haul toolbox, release bar 11 to raise toolbox to access hidden storage compartment 17 and hidden drawer 20, and swivel wheel brake 10 on each swivel wheel 9. The key lock mechanism 8 is one of two security devices used for protection of implements stored in the lockout toolbox. The two extended handles are different in size and used for easier access to pulling toolbox, in conjunction with swivel wheels, to desired position. The two rear wheels are larger in size than the two swivel wheels. An electrical power surge protector 15 is located on the left side of the toolbox to give easier access to connect tools and have them on hand when needed. This electrical power surge protector 15 includes an extension cord 16 to plug into a wall outlet. FIG. 4 is a left detail view of toolbox including extended handle 6 to haul toolbox, release bar 11 to raise toolbox to access hidden storage compartment 17 and hidden drawer 20, and electrical power surge protector 15. FIG. 5 is a front detail view of toolbox including key lock 2, side view of extended handle 6, side view of handle bar 7, swivel wheel 9, swivel wheel brake 10 and regular wheel 14. FIG. 6 is a rear detail view of toolbox including side view of handle bar 7, side view of extended handle 6, rear view of top lid 3, swivel wheel 9, swivel wheel brake 10 and regular wheel 14. This toolbox also includes two hidden storage compartments in order to safely guard implements, in conjunction with key lock 2 mechanisms. The main hidden storage compartment 17 is large enough to hold such items as a small toolbox, drill, extension cords or any other mechanical or electrical implement. The hidden drawer 20, located directly above the hidden storage compartment 17, is large enough to hold implements such as pliers, screwdrivers, or jewel bits. FIG. 12 is a detail view of the inner compartments of the hidden drawer 20 located above the hidden storage compartment 17. Both the hidden storage compartment 17 and the hidden drawer 20 are easily opened by a handle 13 on each side of the compartment. These compartments may be accessed by pulling up the outer casing 35 with a release bar 11 and handle 13 located on each side of such. FIG. 7 is a front detail view of toolbox with view of hidden storage compartment 17 and partial view of the scissor-spring mechanism 19 to keep toolbox raised. FIG. 8 is a rear detail view of toolbox with second door to hidden storage compartment 17 and partial view of scissor-spring mechanism 19 to keep toolbox raised. The scissor-spring mechanism 19 is used for the purpose of holding up the outer casing 35 of the toolbox when accessing the hidden storage compartment 17 and the hidden drawer 20 and for closing the toolbox to secure both. FIG. 9 is a left detail view of open toolbox including electrical power surge protector 15 and hidden drawer 20 above hidden storage compartment 17. FIG. 10 is a right detail view of open toolbox including view of hidden drawer 20 above hidden storage compartment 17 and extended handle 6 to haul toolbox. The springlock mechanism is made to easily pull open the outer casing 35 of the toolbox. The springlock mechanism is made up of a release bar 11, release bar guide 24, pulleys, cable 27, limit plate 28 and stop plate 29. FIG. 11 is a detail view of the springlock mechanism for outer casing 35. In addition to the springlock mechanism, the outer casing 35 is held up with the help of the scissor-spring mechanism 19. The scissor-spring mechanism 19 is made up of two rollers inside a u-channel 32, two scissor bars, a spring 26, and the scissor-spring mechanism base 34. Each roller 31, located inside the u-channel 32, is connected to a scissor bar 33. Both scissor bars are attached to the scissor-spring mechanism base 34 and are separated and joined together by a spring 26. FIG. 14 is a detail view of the inside of the scissor-spring mechanism 19. The Lockout toolbox is suspended on a frame, held together by support bars, in which the swivel tires and regular tires are attached. FIG. 13 is a bottom detail view of the toolbox showing the swivel tires, regular tires and frames. The Lockout Toolbox may be fabricated out of aluminum, plastic or other metals.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A lockout tool box for facilitating the tools to be stored in a protective manner, comprising:
means for opening top of box;
means for security of top lid;
means for covering top compartment of toolbox, manually assembled to said means for security of top lid, and horizontally screwed to said means for opening top of box;
means for opening top lid, tightly screwed to said means for covering top compartment of toolbox;
means for inside view of top cabinet, tightly screwed to said means for opening top lid;
means for pulling toolbox;
means for guiding toolbox, tightly screwed to said means for inside view of top cabinet;
means for securing inside of toolbox, tightly screwed to said means for inside view of top cabinet;
means for easier movement of toolbox;
means for braking toolbox from movement, rigidly connected to said means for easier movement of toolbox;
means for opening and closing hidden compartments of toolbox;
means for <purpose>;
means for help on lifting toolbox;
means for rolling toolbox to desired destination;
means for easier access of plug-in of electric tools;
means for extension of power surge protector, rigidly connected to said means for easier access of plug-in of electric tools;
means for hiding and securing tools;
means for opening hidden compartment, rigidly screwed to said means for hiding and securing tools;
means for help of opening of toolbox;
means for extra storage of tools and accessories, rigidly welded to said means for hiding and securing tools;
means for opening hidden drawer, rigidly screwed to said means for extra storage of tools and accessories;
means for organization of tools and accessories, rigidly welded to said means for extra storage of tools and accessories;
means for <purpose>;
means for <purpose>;
means for <purpose>, movably connected to said means for <purpose>;
means for <purpose>, movably connected to said means for <purpose>;
means for limiting excessive opening of toolbox, rigidly connected to said means for <purpose>, and rigidly connected to said means for opening and closing hidden compartments of toolbox;
means for <purpose>, movably connected to said means for <purpose>, and rigidly connected to said means for <purpose>;
means for <purpose>, rigidly screwed to said means for hiding and securing tools, rigidly screwed to said means for rolling toolbox to desired destination, and rigidly screwed to said means for easier movement of toolbox;
means for <purpose>;
means for <purpose>, rollably connected to said means for <purpose>;
means for <purpose>, movably connected to said means for <purpose>;
means for <purpose>, movably connected to said means for <purpose>, and rigidly connected to said means for <purpose>; and
means for protection of inner portion of toolbox, rigidly screwed to said means for <purpose>, removably screwed to said means for easier access of plug-in of electric tools, rigidly screwed to said means for help on lifting toolbox, rigidly screwed to said means for opening and closing hidden compartments of toolbox, movably connected to said means for pulling toolbox, and rigidly screwed to said means for inside view of top cabinet.

2. A lockout tool box for facilitating the tools to be stored in a protective manner, comprising:
a front handle, for opening top of box;
a key lock, for security of top lid;
a top lid, for covering top compartment of toolbox, manually assembled to said key lock, and horizontally screwed to said front handle;
a hinges, for opening top lid, tightly screwed to said top lid;
a top compartment, for inside view of top cabinet, tightly screwed to said hinges;
an extended handle, for pulling toolbox;
a handle bar, for guiding toolbox, tightly screwed to said top compartment;
a key lock mechanism, for securing inside of toolbox, tightly screwed to said top compartment;
a swivel wheel, for easier movement of toolbox;
a swivel wheel brake, for braking toolbox from movement, rigidly connected to said swivel wheel;
a release bar, for opening and closing hidden compartments of toolbox;
a bolt, for <purpose>;
a handle, for help on lifting toolbox;
a wheel, for rolling toolbox to desired destination;
a power surge protector, for easier access of plug-in of electric tools;
an extension cord, for extension of power surge protector, rigidly connected to said power surge protector;
a hidden storage compartment, for hiding and securing tools;
a hidden storage compartment handle, for opening hidden compartment, rigidly screwed to said hidden storage compartment;
a scissor-spring mechanism, for help of opening of toolbox;
a hidden drawer, for extra storage of tools and accessories, rigidly welded to said hidden storage compartment;
a hidden drawer handle, for opening hidden drawer, rigidly screwed to said hidden drawer;
a hidden drawer compartment, for organization of tools and accessories, rigidly welded to said hidden drawer;
a release bar guide, for <purpose>;
a pullies, for <purpose>;
a spring, for <purpose>, movably connected to said pullies;
a cable, for <purpose>, movably connected to said pullies;
a limit plate, for limiting excessive opening of toolbox, rigidly connected to said release bar guide, and rigidly connected to said release bar;
a stop plate, for <purpose>, movably connected to said cable, and rigidly connected to said release bar guide;
a support bar, for <purpose>, rigidly screwed to said hidden storage compartment, rigidly screwed to said wheel, and rigidly screwed to said swivel wheel;
a roller, for <purpose>;
an u-channel, for <purpose>, rollably connected to said roller;
a scissor bar, for <purpose>, movably connected to said roller;
a scissor-spring mechanism base, for <purpose>, movably connected to said scissor bar, and rigidly connected to said support bar; and
an outer casing, for protection of inner portion of toolbox, rigidly screwed to said support bar, removably screwed to said power surge protector, rigidly screwed to said handle, rigidly screwed to said release bar, movably connected to said extended handle, and rigidly screwed to said top compartment.

3. A lockout tool box for facilitating the tools to be stored in a protective manner, comprising:
a front handle, for opening top of box;
a key lock, for security of top lid;
a top lid, for covering top compartment of toolbox, manually assembled to said key lock, and horizontally screwed to said front handle;
a hinges, for opening top lid, tightly screwed to said top lid;
a top compartment, for inside view of top cabinet, tightly screwed to said hinges;
an extended handle, for pulling toolbox;
a handle bar, for guiding toolbox, tightly screwed to said top compartment;
a key lock mechanism, for securing inside of toolbox, tightly screwed to said top compartment;
a swivel wheel, for easier movement of toolbox;
a swivel wheel brake, for braking toolbox from movement, rigidly connected to said swivel wheel;
a release bar, for opening and closing hidden compartments of toolbox;
a bolt, for <purpose>;
a handle, for help on lifting toolbox;
a wheel, for rolling toolbox to desired destination;
a power surge protector, for easier access of plug-in of electric tools;
an extension cord, for extension of power surge protector, rigidly connected to said power surge protector;
a hidden storage compartment, for hiding and securing tools;
a hidden storage compartment handle, for opening hidden compartment, rigidly screwed to said hidden storage compartment;
a scissor-spring mechanism, for help of opening of toolbox;
a hidden drawer, for extra storage of tools and accessories, rigidly welded to said hidden storage compartment;
a hidden drawer handle, for opening hidden drawer, rigidly screwed to said hidden drawer;
a hidden drawer compartment, for organization of tools and accessories, rigidly welded to said hidden drawer;
a release bar guide, for <purpose>;
a pullies, for <purpose>;
a spring, for <purpose>, movably connected to said pullies;
a cable, for <purpose>, movably connected to said pullies;
a limit plate, for limiting excessive opening of toolbox, rigidly connected to said release bar guide, and rigidly connected to said release bar;
a stop plate, for <purpose>, movably connected to said cable, and rigidly connected to said release bar guide;
a support bar, for <purpose>, rigidly screwed to said hidden storage compartment, rigidly screwed to said wheel, and rigidly screwed to said swivel wheel;
a roller, for <purpose>;
an u-channel, for <purpose>, rollably connected to said roller;
a scissor bar, for <purpose>, movably connected to said roller;
a scissor-spring mechanism base, for <purpose>, movably connected to said scissor bar, and rigidly connected to said support bar; and
an outer casing, for protection of inner portion of toolbox, rigidly screwed to said support bar, removably screwed to said power surge protector, rigidly screwed to said handle, rigidly screwed to said release bar, movably connected to said extended handle, and rigidly screwed to said top compartment.
